(19) United States
(12) Patent Application Publication
(10) Pub. No.: US 2026/0160169 A1
(43) Pub. Date: Jun. 11, 2026

(54) Turbine Blade

(71) Applicant: Siec Badawcza Lukasiewicz-Instytut Lotnictwa, Warszawa (PL)

(72) Inventors: Grzegorz Moneta, Warszawa (PL); Michal Fedasz, Warszawa (PL); Michal Szmidt, Ksiazenice (PL); Slawomir Cieslak, Lublin (PL); Wieslaw Krzymien, Poznan (PL)

(73) Assignee: Siec Badawcza Lukasiewicz-Instytut Lotnictwa, Warszawa (PL)

(21) Appl. No.: 18/976,507

(22) Filed: Dec. 11, 2024

Related U.S. Application Data
(63) Continuation of application No. PCT/IB2023/056035, filed on Jun. 12, 2023.

(30) Foreign Application Priority Data
Jun. 12, 2022 (PL) P.441454

(51) Int. Cl. F01D 5/28

(52) U.S. Cl. CPC F01D 5/28; F01D 5/16; F05D 2220/32; F05D 2230/30; F05D 2300/17

(57) ABSTRACT

A turbine blade for use in a turbine engine or a gas turbine comprises a locking portion and an airfoil with a uniform structure, in which there is at least one pocket filled with powder. In the at least one pocket there is at least one pin connected to the airfoil and at least one bar connected to the airfoil and/or at least one bar connected to the pin.

### CROSS-REFERENCE TO RELATED APPLICATIONS

The instant application claims priority to International Patent Application No. PCT/IB2023/056035, filed Jun. 12, 2023, and to Polish Patent Application No. P.441454, filed Jun. 12, 2022, each of which is incorporated herein in its entirety by reference.

### FIELD OF THE DISCLOSURE

The present disclosure generally relates to a turbine blade and, more particularly, to a blade for use in turbine engines and gas turbines.

### BACKGROUND OF THE INVENTION

Since the beginning of the existence of turbojet engines, fatigue failure to the blades caused by vibrations was the main challenge in operating the engine. This problem has not yet been fully solved, since high cycle fatigue (HCF) is the main cause of failures of turbine engines. In the case of rotor blades, their vibrations lead to cyclic oscillations, which result in cyclic stresses and deformations under the difficult conditions of high centrifugal forces, high temperature and pressure. Such combination of medium stresses and an amplitude of stresses in the blades of rotor machines often leads to instability of operation of these devices and their malfunctions, in particular under the conditions of resonance.

Blade vibration amplitudes are usually reduced by the use of bandages, shelves or friction dampers below the root. Each of these solutions entails reduction in the performance of the machine, including disruption in the flow of gas, an increase in the load of the centrifugal force, and introduction of the risk of accelerated creep in the material of the element. Therefore, there is a search for solutions which would increase the damping of vibrations, in particular under the conditions of resonance, which would have minimal negative impact on the performance of the machine.

The patent application EP0926312A2 discloses a blade comprising a metal airfoil with first and second opposite sides extending radially between the root and the tip of the airfoil, and axially between a leading edge and a trailing edge. The airfoil further includes pockets disposed in the first side, having elastomeric fillers bonded therein. A panel is bonded to the filler along the pocket for allowing differential movement there between for damping the vibrations of the blade. Various kinds of vibrations are damped depending on the used elastomeric material. The filler may take any form such as an elastomeric-like rubber or fluorosilicone molded and cured to bond in the pockets, the filler having lower density than the metal of which the airfoil is made. The use of the filler provides internal damping of the vibrations, which reduces the amplitude of vibrations of the airfoil during operation.

The patent description EP3018292B1 in turn discloses a turbine blade comprising a surface, a recess within the surface, and a damping inlay within the recess, wherein the damping inlay comprises a chamber and a damping material disposed within the chamber. The damping material can, e.g., have the form of powder.

The structural feature of the pockets with non-fused powder is the introduction of two main damping mechanisms. The first one is a change in the properties of the material between the solid area and the powder area—the wave propagates along various media causing changes in the propagation speed of the wave, and causing multiple reflections of the wave. The second damping mechanism is the dissipation of friction between the particles of powder. Unfortunately, the dissipation of energy in powder caused by relative movements between the particles is the most effective in areas close to the walls of the pockets, and drops in the center of the pocket.

From the patent application DE102018123089A1 it is known a particle damper system comprising a base body with a cavity in which at least one spring element is arranged. Further, within the cavity the particles are arranged. The spring element is formed from at least one spring rod and at least one weight that is arranged at a first end of the spring rod. The at least one spring rod is fixed at its second end to an inner wall of the base body and is at least partially in contact with the particles. The particle damper system achieves a damping effect by dissipating the kinetic energy by the relative movement of the base body to the spring element. The particle damper system is to be fixed in or on a component and thus to dampen mechanical oscillations, which correspond to vibrations up to and including impacts, of the component. Examples of such components include those used in automobile construction or turbine housings.

The patent description US2021/372286 discloses a nested lattice structure for use in a damping system for a turbine blade comprising a first lattice structure and second lattice structure. A first lattice structure comprising a first and a second outer passage, wherein both include a hollow interior and an outer node including a hollow interior and forming an intersection of the first outer passage and the second outer passage. The nested lattice structure includes a second lattice structure nested within the hollow interior of the first lattice structure. Each of the first and second lattice structures dampen vibrations from the blade portion. By coupling each of the lattice structures, to only a single portion (albeit different portions) of the turbine blade, and by dimensioning the lattice structures to allow relative motion there between, the damping system may simultaneously dampen multiple vibratory modes from multiple locations on the turbine blade.

### BRIEF SUMMARY OF THE INVENTION

In view of the foregoing, it is desirable to develop a technical solution that would allow for improving the dissipation of energy in the entire volume of powder in the pockets, and therefore increase the efficiency of damping the vibrations.

In one aspect, the present disclosure describes a turbine blade, in particular the blade of a turbine engine or a gas turbine, comprising a locking portion and an airfoil with a uniform structure, in which there is a plurality of pockets filled with powder. In one aspect, the plurality of pockets are distributed in the volume of the airfoil in a matrix array, and said pockets comprise: at least one cuboid block connected to the airfoil, and cuboid blocks placed in the pockets have various dimensions, and at least one rod connected to the airfoil and/or at least one rod connected to the cuboid block.

The introduction of a pocket and/or pockets filled with powder, in which there are the cuboid block and the rods, into the volume of the blade allows for transferring the energy of vibrations into the entire volume of powder, making the damping of vibrations more effective. As a result, during vibrations of the blade, a considerable increase in the dissipation of energy in the powder is achieved, and therefore better damping of vibrations. The use of the described configuration significantly reduces the amplitudes of vibrations, primarily under the conditions of resonance, thus considerably reducing the risk of failure.

### BRIEF DESCRIPTION OF THE SEVERAL VIEWS OF THE DRAWING(S)

FIG. 1 is a schematic view of a turbine blade in accordance with the disclosure, the turbine blade comprising visible pockets arranged in an airfoil volume of the turbine blade; for clarity of the figure, the powder is not visible.

FIG. 2 is a schematic of a sample pocket of the turbine blade according to one embodiment of the present disclosure; for clarity of the figure, the powder is not visible.

FIG. 3 is a schematic of a sample pocket of the turbine blade according to another embodiment of the disclosure; for clarity of the figure, the powder is not visible.

FIGS. 4A, 4B, 4C, and 4D are fragmented views of a turbine blade in accordance with the disclosure in a longitudinal section across a pocket, upon cutting the element and pouring out the powder.

FIG. 5 is a section view of a cut turbine blade in accordance with the disclosure.

### DETAILED DESCRIPTION OF THE INVENTION

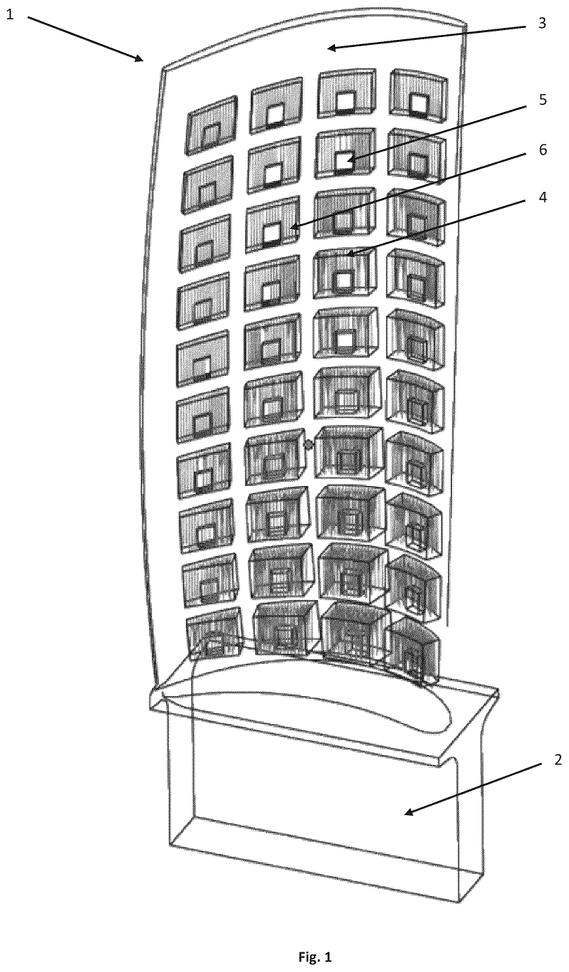

As presented in FIG. 1, the turbine blade 1, in particular the blade of a turbine engine or a gas turbine, comprises a locking portion 2 and an airfoil 3 with a uniform structure.

In the structure of the airfoil 3 there are a plurality of pockets 4, arranged in a matrix array, filled with non-fused powder of the material of which the turbine blade 1 is made. In this embodiment, the matrix array comprises four columns and ten rows. The number of pockets in other embodiments of the invention may vary, and their number, size, and position depend on the needs specified for a given turbine blade. The distribution of pockets 4 in the matrix array is preferable from the point of view of static strength of the blade. In the presented embodiment, the pockets 4 are distributed in the entire volume of the airfoil 3, which has preferable impact on maximizing the damping effect.

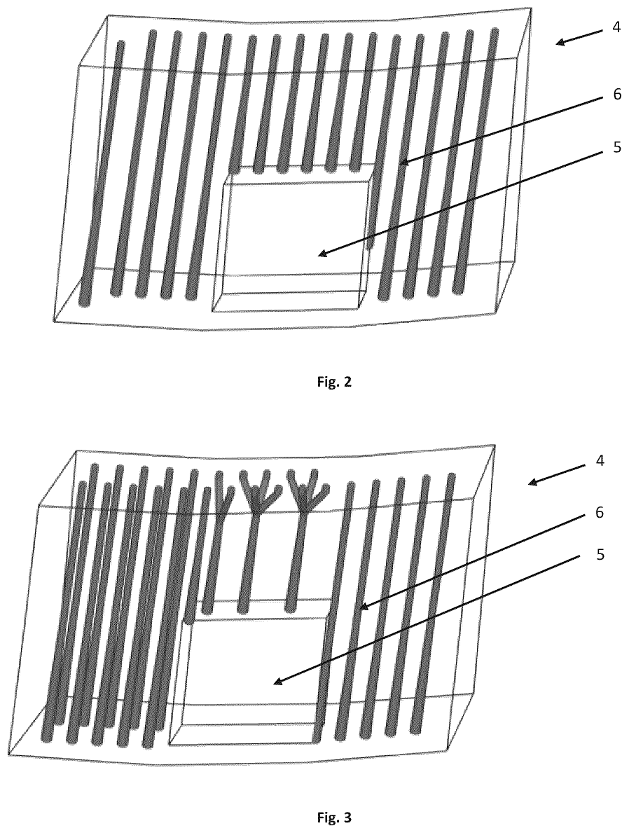

In the pockets 4, there are cuboid blocks 5 connected to the airfoil 3. In the pockets 4, there are also rods 6 connected to the airfoil 3, and rods 6 connected to the cuboid block 5. Sample views of the pockets 4 are presented in FIGS. 2 and 3. The rods 6 can also have an openwork structure.

The cuboid blocks 5 placed in the pockets 4 have various dimensions. A cuboid block with specific dimensions is characterized by a given frequency of damping vibrations, which is characteristic of it. The use of various dimensions of cuboid blocks in the pockets results in damping a broad spectrum of resonance frequencies and forms of vibrations (intentional dephasing of vibrations).

Some of the pockets comprise rods 6, some of which have both ends connected to the airfoil 3, which enables damping vibrations with a higher frequency. The remaining part of the rods 6 connect the cuboid block 5 to the wall of the pocket 4, improving the transfer of energy into the powder.

Another part of the pockets 4 in turn comprises rods 6, whose only one end is connected to the airfoil 3 or to the cuboid block 5, which allows for damping vibrations of lower frequencies. The number and arrangement of the rods 6 in the pockets depend on the dimensions of the pockets.

The rods 6 are arranged substantially parallel with respect to each other, due to which the entire volume of the powder is ‘activated’, which means that its entire volume actively participates in the damping of vibrations. This prevents the existence of the so-called “ineffective spaces,” which do not participate in damping the vibrations. The number and arrangement of the rods 6 (rows/columns) depend on the size of the pocket. However, they are supposed to enable uniform transfer of wave energy to the volume of the non-fused powder.

The turbine blade 1 may be made of an alloy based on nickel, cobalt or tungsten (in the case of military applications). When used in compressors, the turbine blade may in turn be made of an alloy based on aluminum or magnesium. The turbine blade may also be made of steel, for example 316L, St12T, 17-4PH, St T17/13W, and 15-5PH steel.

The turbine blade 1 is formed using an additive manufacturing technique, and more precisely a Laser Powder Bed Fusion (LPBF) technique. The LPBF technology (Laser Powder Bed Fusion) is based on applying thin layers of metal powder, which powder is subsequently melted by means of a laser beam in accordance with the geometry of the manufactured element. Using the LPBF process, a turbine blade with unique inner geometry is manufactured, within which pockets 4 with cuboid blocks 5 and rods 6 are formed, which pockets 4 are filled with non-fused powder. During the manufacturing of the blade, the powder present in the location of the pocket 4 being formed does not undergo melting. As a result, the airfoil 3, the cuboid blocks 5, and the rods 6 form a monolithic element, and the non-fused powder remaining in the formed pockets ensures the damping of vibrations.

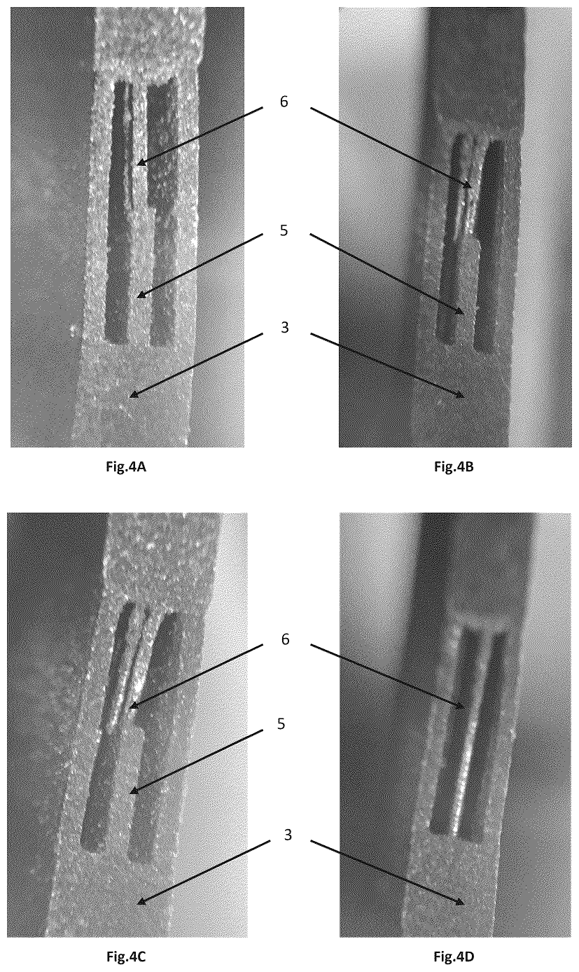

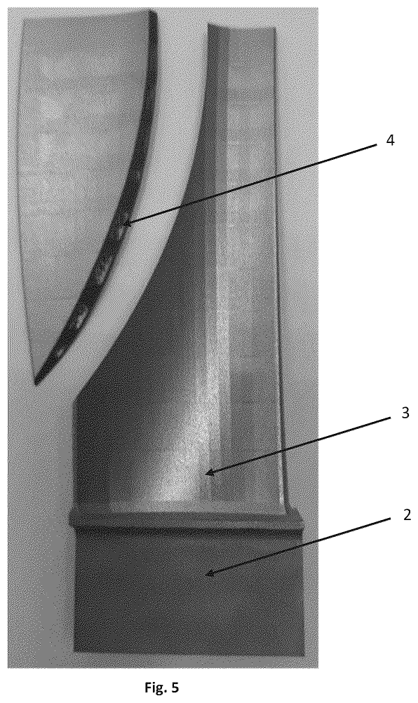

In the volume of the turbine blade 1 there are pockets 4 in which there are the cuboid block 5 and the rods 6, surrounded by non-fused powder, as shown in the embodiments of FIGS. 4A, 4B, 4C and 4D. During vibrations of the turbine blade 1, the energy is dissipated by friction between the powder particles. The rods 6 and the cuboid block 5 present in the pockets 4 cause transfer of the energy of vibrations into the entire volume of the powder, making the damping of vibrations more effective than in solutions known from prior art. The solution proposed in the present invention considerably reduces the amplitudes of vibrations, primarily under the conditions of resonance, thus considerably reducing the risk of malfunctions.

In one embodiment, both ends of the at least one rod are connected to the airfoil. Bilateral connection of the rods to the airfoil allows for damping vibrations with a higher frequency. The connection of only one end of the rod to the airfoil or to the cuboid block in turn allows for damping vibrations with lower frequencies.

It is preferable when at least one rod in the pocket connects the cuboid block to a wall of the pocket. Such arrangement of the rods improves the transfer of the energy of vibrations into the powder. At the same time, it allows for damping vibrations with an even higher frequency than in the case of bilateral connection of the rod to the airfoil.

It is desirable for the rods to be arranged substantially parallel with respect to each other, due to which the entire volume of powder is activated to absorb the energy of vibrations. This avoids the existence of locations in which there is no absorption of the energy of vibrations.

Preferably, the rods placed in the pockets have an openwork structure. The openwork structure of the rods will increase the intensity of engagement between the powder and the rods, thus increasing the efficiency of damping. As used herein, the term “openwork structure” refers to a structure that is decorated with holes, piercings, or gaps that extend through or are formed within a solid material.

It is preferable for the cuboid blocks placed in the pockets to have various dimensions. A cuboid block with specific dimensions is characterized by a given frequency of damping vibrations, which is characteristic of it. The use of various dimensions of the cuboid blocks in the pockets results in damping a broad spectrum of resonance frequencies and forms of vibrations (intentional dephasing of vibrations).

It is particularly preferable when the turbine blade according to the invention comprises a plurality of pockets distributed in the entire volume of the airfoil, which allows for achieving a maximum damping effect.

The distribution of pockets in a matrix array is in turn preferable from the point of view of static strength of the turbine blade due to its orientation parallel to the centrifugal force acting on the blade.

Due to the technology of production, it is preferable when the pocket is filled with the material of which the airfoil is made, in pulverized form. This allows for achieving closed pockets, due to which the powder does not pour between the pockets, which could lead to is concentration in some pockets, leaving other pockets not filled.

Preferably, the airfoil, the cuboid block, and the rods form a monolithic element, which has a preferable effect on the efficiency of transferring the energy of vibrations into the volume of the powder—the wave propagates in a solid medium much better than in powder.

It is recommended for the turbine blade according to the invention to be made using an additive manufacturing technique, most preferably a Laser Powder Bed Fusion (LPBF) technique.

Preferably, the turbine blade is made of an alloy based on nickel, cobalt or tungsten (in military applications). When used in compressors, the turbine blade is in turn made of an alloy based on aluminum or magnesium. The turbine blade may also be made of steel.

The solution according to the embodiments of the disclosure allow for transferring the energy of vibrations into the entire volume of powder, making the damping of vibrations more effective. As a result, during vibrations of the turbine blade, a considerable increase in the dissipation of energy is achieved in the powder, and therefore so is better damping of vibrations.

The solution according to the disclosure allows for considerable reduction in the amplitude of vibrations, primarily under the conditions of resonance, thus considerably reducing the risk of failure.

The proposed solution according to the disclosure, which comprises pockets with powder comprising cuboid blocks and rods, provides excellent improvement in damping compared to solid parts, almost by two orders of magnitude.

The solution according to the disclosure allows for reducing the mass of the turbine blade. When using the solution according to the invention, it is possible to reduce the mass compared to the structure of a solid blade, at the same time improving the damping of vibrations.

Moreover, the solution according to the disclosure also allows for fine-tuning the frequencies of the damped vibrations without changing the airfoil blade profile.

The manufacturing of the blade using a Laser Powder Bed Fusion (LPBF) technique in turn allows for shortening the manufacturing time of the blade (a smaller volume of the element has to be fused, reducing the time of manufacturing).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCES

1—turbine blade
2—locking portion
3—blade airfoil
4—pockets
5—cuboid block
6—rod

What is claimed is:

1. A turbine blade for use in a turbine engine or a gas turbine, comprising:
a locking portion; and
an airfoil having a uniform structure, the airfoil comprising a plurality of pockets filled with powder;
wherein the plurality of pockets is distributed in a volume of the airfoil in a matrix array; and
wherein each pocket in the plurality of pockets comprises at least one cuboid block connected to the airfoil and placed in each pocket;
wherein the cuboid blocks in the plurality of pockets have various dimensions; and
wherein each pocket in the plurality of pockets further comprises at least one rod connected to the airfoil and/or at least one rod connected to the cuboid block of each pocket.

2. The turbine blade according to claim 1, wherein the at least one rod has two ends, and wherein both ends of the at least one rod are connected to the airfoil.

3. The turbine blade according to claim 1, wherein one end of the rod is connected to the airfoil or to the cuboid block.

4. The turbine blade according to claim 1, wherein at least one rod connects the cuboid block to the wall of each pocket.

5. The turbine blade according to claim 1, wherein the at least one rod in each of the plurality of pockets is oriented substantially parallel relative to rods disposed in other pockets of the plurality of pockets.

6. The turbine blade according to claim 1, wherein the rods in the plurality of pockets have an openwork structure.

7. The turbine blade according to claim 1, wherein each of the plurality of pockets is filled with a pulverized material of a material that the airfoil is made.

8. The turbine blade according to claim 1, wherein the airfoil, the cuboid blocks and the rods disposed in the plurality of pockets form a monolithic element.

9. The turbine blade according to claim 1, wherein the turbine blade is formed using an additive manufacturing technique.

10. The turbine blade according to claim 9, wherein the additive manufacturing technique uses a Laser Powder Bed Fusion (LPBF) technique.

11. The turbine blade according to claim 7, wherein the material is an alloy based on nickel, cobalt, tungsten, aluminum or magnesium.

12. The turbine blade according to claim 7, wherein the material is steel.
